(19) United States
(12) Patent Application Publication
(10) Pub. No.: US 2021/0406908 A1
(43) Pub. Date: Dec. 30, 2021

(54) PROCESSING THROTTLES TO ENFORCE ACCOUNT USAGE LIMITATIONS

(71) Applicant: PayPal, Inc., San Jose, CA (US)

(72) Inventor: Alexander C. Simonson, San Francisco, CA (US)

(21) Appl. No.: 16/914,188

(22) Filed: Jun. 26, 2020

(51) Int. Cl. G06Q 20/42; G06Q 20/40; G06Q 20/22; G06Q 20/38

(52) U.S. Cl. CPC G06Q 20/42; G06Q 20/384; G06Q 20/223; G06Q 20/405

(57) ABSTRACT

There are provided systems and methods for processing throttles to enforce account usage limitations. A user may engage in a transaction with another user, such as a purchase of goods, services, or other items a merchant using a physical payment card. An online transaction processor may provide a monitoring operation to enforce an electronic transaction processing limit on use of the payment card. This limit may correspond to a processing throttle, which may limit use of the payment card below a maximum amount of usage allowed for the payment card. When the payment card is utilized, the online transaction processor may determine that the throttle is violated by the usage and prevent the usage of the payment card. The online transaction processor may then contact the user of the transaction and allow for removal or adjustment of the throttle.

### TECHNICAL FIELD

The present application generally relates to data processing and more particularly to providing one or more selectable throttles to prevent account usage when a data processing transaction exceeds the selectable throttle(s).

### BACKGROUND

Users may utilize online transaction processors for processing payments between different entities through device applications and digital accounts. Further, these online transaction processors may also provide physical payment cards for in-person transaction processing and use at merchant locations. When extending payment cards for users to utilize with in-person transactions, the users may receive a credit limit and/or may be capable of utilizing a balance or credit, real funds, or virtual funds linked to the payment card. While users may desire to have additional credit or funds available (e.g., to enable more purchasing power or improve a credit rating of the user), the user may not want to have the entire balance or limit available based on budgets and/or to avoid fraud. Moreover, since the account is utilized with just the payment card and not a computing device, such as a mobile phone, the user may not be capable of viewing a statement balance for a statement cycle, a credit limit or amount of used credit, and/or other available funds. Thus, the online transaction processor may want to enforce preemptive limitations on the card and/or account. Additionally, with the increasing threat of cyber-attacks, phishing schemes, and malware that may compromise the user's payment card and/or digital account, the user and online transaction processor may desire to enforce preemptive limits on card and account usage.

### BRIEF DESCRIPTION OF THE DRAWINGS

FIG. 1 is a block diagram of a networked system suitable for implementing the processes described herein, according to an embodiment;

FIGS. 2A-B are exemplary interfaces for establishing a processing limit on a digital account and payment card with an online transaction processor, according to an embodiment;

FIG. 3 is an exemplary interface for notifying a user through a mobile account when a processing throttle is reached, according to an embodiment;

FIG. 4 is a flowchart of an exemplary process for processing throttles to enforce account usage limitations, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for processing throttles to enforce account usage limitations. Systems suitable for practicing methods of the present disclosure are also provided.

A user may utilize a payment card to process payments through an electronic card or a transaction network associated with a backend payment processor or other entity on the network. This payment card may be linked to a digital account of the user with an online transaction processor, such as a payment service provider (e.g., PayPal®), which may provide electronic transaction processing services to users through the account and one or more websites and/or applications of the online transaction processor or a merchant. The payment card may be established with a credit limit and/or may have a balance or value available for use with the payment card. The online transaction processor may include an integration with the electronic card network that allows for data exchange and communications between the two networks. The user may establish one or more spending or transaction processing limits on the payment card and/or digital account for use of the credit limit and/or balance, which may include different throttle parameters. For example, a transaction processing limit and/or spending throttle may limit available credit to the payment card to less than a maximum amount of credit, such as $3,000 even though the maximum credit limit is $10,000. Thereafter, the online transaction processor may monitor the payment card and/or digital accounts usage on an electronic card network to enforce the spending throttle and limit card usage. This data processing may occur in certain time intervals or after a time period or cycle, such as weekly, monthly, or the like (e.g., after a billing cycle). Thereafter, as the user utilizes the payment card to process transactions, the online transaction processor may prevent data processing if a throttle is exceeded. Additionally, the online transaction processor may alert the user if the throttle is exceeded and provide an option to remove the throttle, adjust the throttle, and/or approve the transaction.

In this regard, a user may process a purchase of the items via a digital account and/or payment card that provides values, credit, or other funds to the user through an online transaction processor and/or electronic card network. Selection of one or more items in an in-person transaction at a physical merchant location or via an online marketplace or other digital platform may require a payment instrument from the user for electronic transaction processing. A user may pay for one or more transactions using a digital wallet or other account with an online service provider or other transaction processor (e.g., PayPal®), as well as the payment card (e.g., through proffering the card and having the card data read or by entering card details and/or account numbers). An account and/or corresponding payment card with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information.

The user may also be required to provide financial information, including payment card (e.g., credit/debit card) information, bank account information, gift card information, benefits/incentives, and/or financial investments, when processing transactions with merchants and/or other users or entities. Account creation may also be used to establish account funds and/or values, such as by transferring money into the account and/or establishing a credit limit and corresponding credit value that is available to the account and/or card. The online payment provider may provide digital wallet services, which may offer financial services to send, store, and receive money, process financial instruments, and/or provide transaction histories, including tokenization of digital wallet data for transaction processing. The application or website of the service provider, such as PayPal® or other online payment provider, may provide payments and the other transaction processing services. The digital account linked to the payment card may also correspond to a peer-to-peer payment account and/or social networking account, such as one that may be used on a peer-to-peer payment and social networking platform provided by the online transaction processor. Moreover, the digital account may be utilized through one or more mobile applications for mobile devices.

In order to pay for the transaction (e.g., a transfer or payment to another user, merchant, or other entity), the user may provide the payment card or funding source information, or may login to an account with the service provider through authentication information. A payment may then be issued to the other party to the transaction and transaction information may be stored with the digital wallet or account. In this regard, a digital token or other data may authorize and/or authenticate the user for their digital wallet use and/or a payment instrument in the digital wallet, which may be transmitted to another party (e.g., the agent and/or merchant) for payment processing. The data may be stored to one or more storage mediums on the payment card, such as a magnetic stripe or an EMV chip. For example, a POS device and/or card reader may be used to read the card data from a merchant device at a merchant location. This may allow for single user payments through a payment account and/or digital wallet. In some embodiments, the account and/or digital wallet may be linked to the user's device or application and a one-touch checkout process may be authorized by the user, where selection of the account or other data may automatically initiate the process to purchase the item using the account and/or digital wallet.

Once the payment card is opened, such as a credit and/or debit card is opened, established, and/or linked to the user's digital account, the user may receive an available balance that may be utilized by the user. This may correspond to a real or virtual asset or value and may be a revolving credit limit extended to the user. The user may desire to enforce limitations on electronic transaction processing and spending of the available balance, such as the revolving credit limit. For example, a high maximum credit limit may be extended to the user (e.g., $5,000, $10,000, $30,000), however, the high maximum credit limit that was extended would negatively affect the user's budget if the user were to spend up to this limit. In this regard, the user's budget may only be able to afford $2,000 of credit repayments or balance payments (e.g., a payoff of the extended credit's balance) in a revolving credit billing cycle or time period, whether temporary or recurring. Thus, the user may establish a lower limit that prevents electronic transaction processing using the payment card and/or digital account.

In this regard, the user may utilize a mobile resident application on a computing device and/or a website to access one or more spending throttle and/or transaction processing limits with the payment card and/or digital accounts credit limit. These interfaces may allow the user to set the spending throttle below the maximum credit limit extended to the user. For example, where a maximum credit limit is $10,000, the user may set a spending throttle at any level between $1-$9,999. The user may set the spending throttle at a level that corresponds to the user's budget during a specific time period or a recurring period. In the previous example, the user may set the spending throttle at $2,000 as the amount that corresponds to the user's budget. The spending throttle may correspond to an electronic transaction processing limit that prevents use of extended credit or other balance using the payment card and/or digital account when performing electronic transaction processing. For example, the spending throttle may prevent the payment card from being used in a transaction at a merchant location or may prevent the digital account and/or payment card from being processed through an online electronic transaction. Thus, if the spending throttle or other established threshold on credit usage of the extended credit is met or exceeded, the online transaction processor may prevent processing, such as by declining the transaction and/or instructing the backend credit processor system and electronic card network to decline the transaction and prevent transaction processing and use of the credit limit.

The user may set different spending throttles and/or limits of electronic transaction processing using the balance of extended credit or other value through the payment card and/or digital account. For example, the spending throttle may be a static amount, such as the $2,000 limit that prevents the user from exceeding that limit, and therefore does not reset after a time period. The spending throttle may also be for a dynamic or variable limit, such as $2,000 in a month and may therefore reset after the time limit. The spending throttle may also be for a number of transactions or a single transaction cap. Additionally, other data may also be used to set different types of spending throttles, for example, based on MCCs and transactions categories, a time of day, a purchase type, a location and/or a merchant associated with the location, other users involved with the transaction, while traveling or travel-based expenditures, employment or occupation-based expenditures, and the like. Where the spending throttle limits a particular type of transaction processing and/or is a dynamic or variable limit, the spending throttle may be for a time period, such as a billing cycle, and may reset after the time period. Additionally, the spending throttle may be particular to one payment card out of a plurality of cards that are linked to or have access to the extended credit or other balance. For example, the spending throttle may be for a child's payment card for a family that uses a single account and credit balance. Additionally, the spending throttle may be tiered and may release additional credit or other funds and value progressively, such as when each spending throttle is reached, during different days or months, and the like. The spending throttle may also be time, season, or event-based, such as by releasing additional funds during a holiday season, when a user or associated user has a birthday or other life event, and/or based on different weeks or months (e.g., due to upcoming bills, expected purchases, and the like).

Thereafter, a transaction may be processed using the payment card and/or digital account, which may generate and process transaction data for the transaction on a digital network. The transaction data may further include information, such as one or more items, item costs (e.g., itemizations) and/or a total cost, a transaction time, a corresponding merchant or merchant identifier, other users involved in the transaction, a transaction location, a merchant category code (MCC) identifying a particular category for each transaction, and/or other transaction data. The online transaction processor may provide electronic transaction processing services used to process the transaction using the transaction data and/or card data. However, in other embodiments, in order to receive this data, the online transaction processor may be required to interface with a backend card processor and/or electronic card or transaction network that transmits, receives, and/or processes the transaction data. In this regard, the online transaction processor may utilize an application programming interface (API) to communicate and integrate with one or more APIs of the electronic card network. This allows the online transaction processor to detect, receive, and process the transaction data, for example, by enforcing spending throttles on transactions that are processed on the electronic card network. Thereafter, the transaction data may be detected and/or transmitted to the online transaction processor via one or more APIs. This may include receiving and processing the data in real-time, such as when the transactions occur in order to enforce spending throttles and other electronic transaction processing limits on the payment card and/or digital account when used for electronic transaction processing on one or more networks.

Thereafter, when the transaction data for a transaction is received by the online transaction processor when the transaction is requested to be processed, the transaction data may then be analyzed to determine whether the transaction complies with or violates the spending throttle(s). This may be done by detecting the transactions on the electronic card network, such as by listening to card reading and/or scanning events and receiving corresponding transaction information, or by monitoring incoming communications from the electronic card network, merchants, point-of-sale (POS) devices, and the like. If the transaction complies with the spending throttle, then the online transaction processor may approve the transaction or allow the transaction to be approved on the electronic card network (e.g., by not declining the transaction or requesting the electronic card network and/or backed credit card processing system to decline the transaction). However, if the transaction violates the spending throttle or otherwise does not comply with the spending throttle (e.g., if the transaction amount causes the balance of the payment card and/or digital account to exceed the spending throttle balance cap), then the online transaction processor may decline the transaction by refusing to process the transaction and/or requesting that the electronic card network and/or backed credit card processing system reject or decline the transaction.

If the transaction exceeds or violates the spending throttle, the online transaction processor may then transmit a message having a notification or alert to a device of the user. The device may be designated by the user for the user's account and/or when establishing the spending throttle, such as a mobile device of the user. The message may include an executable option, operation, and/or selectable interface element to remove or adjust the spending throttle so that the transaction may be processed. The removal may entirely remove the spending throttle so that the entire available balance and/or credit limit is then available through the payment card and/or digital account. The removal may instead include tiered removal of the spending throttle, such as by increasing the spending throttle to a next limit (e.g., from $2,000 to $2,500 or $3,000, which may be designated by the user or automatically increased). In some embodiments, in order to remove or adjust the spending throttle, the user may be required to provide authentication and/or otherwise login or authenticate the user for the payment card and/or digital account.

The removal or adjustment may allow the transaction to be processed, for example, by approving the rejected transaction or allowing a second transaction to then be processed (e.g., by again scanning the payment card and processing the transaction). Additionally, the message may have an option to change the declination of the transaction to approval, which may change the transaction's rejection and declination with the electronic card network and backend card processor. In certain embodiments, the determination of whether to provide the user with the removal option, provide a tiered release of additional balance funds, and/or remove the spending throttle may depend on additional data for the transaction. For example, removal may be limited to certain times of day, transactions, locations, and the like. The notification or alert may be transmitted through text message, such as SMS or MMS, or through another messaging system and protocol, such as instant message, application push notification for a mobile application, email, website chat interface, or the like.

The user may also be provided the option to access the user's digital account and change the spending throttles, for example, by authenticating the user through an application or website and viewing one or more spending throttles with selectable interface options and/or interface fields for input of data to adjust the spending throttles. In some embodiments, after a declined transaction, removal and/or changing of the spending throttles may be time delayed so that the user may consider whether the transaction should be approved. The user may be provided with the option to remove the spending throttle entirely or adjust the spending throttle to another limit or based on another parameter. Thereafter, the online transaction processor may update the spending throttle and continue to monitor the payment card and/or digital account usage for compliance with the updated spending throttle.

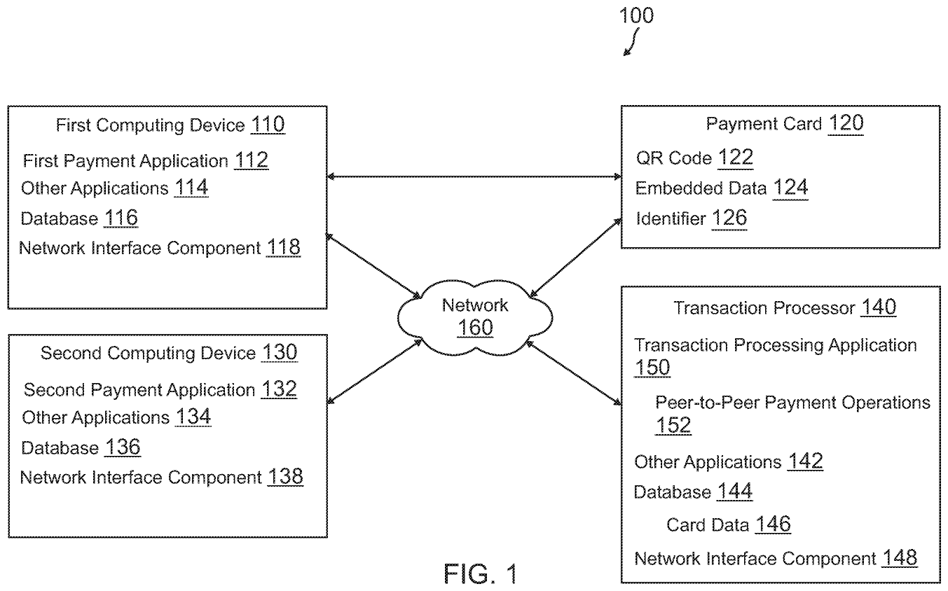

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a first computing device 110, a payment card 120, a second computing device 130, and a transaction processor 140 in communication over a network 160. First computing device 110 may be used to establish a transaction and process a payment for the transaction using data from one or more of payment card 120 and/or second computing device 130. In this regard, when the transaction is processed, the transaction data over an electronic card or transaction network, which may be available over network 160. Second computing device 130 may be used to set spending throttles or other electronic transaction processing limits on use of a balance, such as an amount of a maximum extended credit limit. Transaction processor 140 may then be used to detect the transaction data and determine whether the transaction data complies with the spending limit.

First computing device 110, second computing device 130, and transaction processor 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

First computing device 110 may be implemented using any appropriate hardware and software configured for wired and/or wireless communication with payment card 120, second computing device 130, and/or transaction processor 140 for processing a transaction based on one or more of payment card 120 and/or second computing device 130. First computing device 110 may correspond to an agent or employee of a merchant that provides sales through a physical storefront or an online merchant marketplace, including merchant websites or other online platforms accessible through a browser application or resident device application. In various embodiments, first computing device 110 may be implemented as a personal computer (PC), a smart phone, laptop/tablet computer, wristwatch with appropriate computer hardware resources, other type of wearable computing device, and/or other types of computing devices capable of transmitting and/or receiving data. Although only one computing device is shown, a plurality of computing device may function similarly.

First computing device 110 of FIG. 1 contains a first payment application 112, other applications 114, a database 116, and a network interface component 118. First payment application 112 and other applications 142 may correspond to executable processes, procedures, and/or applications with associated hardware. In other embodiments, first computing device 110 may include additional or different software as required.

First payment application 112 may correspond to one or more processes to execute modules and associated devices of first computing device 110 to provide a convenient interface to permit a merchant for first computing device 110 to enter, view, and/or process one or more items the user wishes to purchase in an in-person or online transaction. In this regard, first payment application 112 may correspond to specialized hardware and/or software utilized by first computing device 110 that may provide transaction processing for the item(s) using financial information from payment card 120 and/or second computing device 130. Thus, first payment application 112 may be implemented as an application having a user interface enabling the merchant to enter and/or view the items a user associated with second computing device 130 wishes to purchase. For example, the user of payment card 120 and second computing device 130 and/or the merchant of first computing device 110 may indicate some item to purchase. This may be based on selected items brought to a register or POS device for first computing device 110, or based on communications associated with a current item, webpage, or interface for an item that second computing device 130 may be viewing. Once generated, first payment application 112 may display and render the interface for the checkout operations to complete a transaction for the item(s) based on processing transaction data with payment card 120 and/or second computing device 130, such as using card data or financial data from payment card 120 and/or second computing device 130.

Prior to payment and transaction processing, first payment application 112 may further enable the merchant to enter coupons and/or discounts for the items, edit the order including adding, removing, and/or modifying items, or other functions with regards the selected items in the purchase and provided through the checkout interface element. Once the items have been finalized for purchase by the user, a total may be calculated, and a transaction may be engaged with the user to complete payment for the selected items, for example, through card data stored to a storage medium (e.g., magnetic stripe and/or EMV chip) of payment card 120 and/or tokenized data or other information from second computing device 130. Thus, first computing device 110 may include a POS checkout component and/or card reader, including a magnetic stripe reader or EMV chip reader. In some embodiments, first payment application 112 may utilize a camera of first computing device 110 to capture a code on payment card 120 and/or presented by second computing device 130 that may be encoded with the payment data or used to receive the payment data. Thus, first payment application 112 may request payment using the provided payment data from payment card 120 and/or second computing device 130. When processing a payment using the provided payment data, a spending throttle may be set on the payment data, such as to limit an amount of available funds or credit associated with the payment data. The transaction data having the corresponding payment or financial data may then be processed over an electronic card network and/or digital payment network. Transaction processor 140 may then receive the transaction data and determine whether the transaction complies with the spending throttle. If so, the transaction may be approved and first payment application 112 may alert the merchant when payment for the transaction for the item(s) is completed, as well as generate a receipt to the user associated with second computing device 130. However, if declined, first payment application 112 may receive a declination of the transaction, and may notify the merchant that the payment has not been completed.

In various embodiments, first computing device 110 includes other applications 114 as may be desired in particular embodiments to provide features to first computing device 110. For example, other applications 114 may include security applications for implementing client-side security features, programmatic client applications for interfacing with appropriate application programming interfaces (APIs) over network 160, or other types of applications. Other applications 114 may also include email, texting, voice and IM applications that allow a user to send and receive emails, calls, texts, and other notifications through network 160. Other applications 114 may also include other location detection applications, which may be used to determine a location for first computing device 110, such as a mapping application. Other applications 114 may include device interface applications and other display modules that may receive input from the user and/or output information to the user. For example, other applications 114 may contain software programs, executable by a processor, including a graphical user interface (GUI) configured to provide an interface to the user. Other applications 114 may therefore use components of first computing device 110, such as display components capable of displaying information to users and other output components, including speakers.

First computing device 110 may further include database 116 which may include, for example, identifiers such as operating system registry entries, cookies associated with first payment application 112 and/or other applications 142, identifiers associated with hardware of first computing device 110, or other appropriate identifiers. Identifiers in database 116 may be used by a payment/service provider to associate first computing device 110 with a particular account maintained by the payment/service provider. Database 116 may also further store received transaction data, as well as processed transaction data. In various embodiments, electronic card network data and identifier, or other information used on a digital payment network, may be stored to database 116.

First computing device 110 includes at least one network interface component 118 adapted to communicate with second computing device 130 and/or transaction processor 140 over network 160. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Payment card 120 may correspond to a physical payment card and/or digital representation of a payment card that may be used to store card data corresponding to financial data used to process transactions. In some embodiments, payment card 120 may correspond to a standard sized card (e.g., ˜85.×54 mm (3.37×2.125 in) card having rounded corners) that include one or more storage mechanisms (e.g., magnetic stripe, EMV chip, NFC chip and/or antenna, or the like). Payment card 120 may also correspond to a key fob or other device that similarly may include a storage mechanism and may store data. In some embodiments, payment card 120 may be virtual and may be stored to another device, such as second computing device 130.

Payment card 120 may include a QR code 122 or be associated with QR code 122, which may link to backend data that allows accessing of a digital account based on encoded data in QR code 122. The encoded data may be dynamically linked to different backend data so that when QR code 122 is read, different actions, operations, and/or data may be accessed and/or utilized. QR code 122 may correspond to a surface of payment card 122 or may otherwise be represented on or with payment card 120, including physical or digital representations of payment card 120. Payment card 120 may also be configured to store card data corresponding to a card account, value balance (e.g., account balance for a debit card), credit balance, or the like as embedded data 124. In other embodiments, embedded data 124 may be stored to other storage mediums, such as a non-transitory memory for an NFC or RFID chip and/or device. Identifier 126 may also be provided on or with payment card 120, which may correspond to a card and/or account identifier. For example, identifier 126 may correspond to a 16 digit or other series of digits and/or alphanumeric codes, that allows for specific identification of an account and use of payment card 120 to process transactions. Identifier 126 may include multiple identifiers, including a user name, an expiration date, and/or a CCV number.

Second computing device 130 may be implemented using any appropriate hardware and software configured for wired and/or wireless communication with first computing device 110, payment card 120, and/or transaction processor 140, which may be used by a user to set spending throttles on processing one or more transaction based on a balance or funds available to one or more of payment card 120 and/or second computing device 130. In various embodiments, second computing device 130 may be implemented as a personal computer (PC), a smart phone, laptop/tablet computer, wristwatch with appropriate computer hardware resources, other type of wearable computing device, and/or other types of computing devices capable of transmitting and/or receiving data. Although only one computing device is shown, a plurality of computing device may function similarly.

Second computing device 130 of FIG. 1 contains a second payment application 132, other applications 134, a database 136, and a network interface component 138. Second payment application 132 and other applications 134 may correspond to executable processes, procedures, and/or applications with associated hardware. In other embodiments, second computing device 130 may include additional or different software as required.

Second payment application 132 may correspond to one or more processes to execute software modules and associated components of first computing device 110 to process electronic transactions at a physical merchant location or over a network with an online marketplace, including establishing spending throttles and/or electronic transaction processing limits on use of a balance, credit limit, and/or other funds (real or virtual) for payment card 120 and/or a digital account. In this regard, second payment application 132 may correspond to specialized hardware and/or software utilized by a user of second computing device 120 to process a transaction and set spending throttles. Second payment application 132 may be utilized enter or receive transaction data for a transaction (e.g., a payment to another entity, such as a user, merchant, or other payee). At a physical merchant location, second payment application 132 may designate the items for purchase or the user may bring items to a checkout, where payment card 120 and/or second computing device 130 may provide card data, account data, or other financial data to process the transaction. With digital transactions, second payment application 132 may designate the items for purchase through the online marketplace for the merchant and provide the card data, account login and/or account data, financial data, or a digital token used to pay for the transaction data and perform transaction processing. Further, second payment application 132 may be used to access one or more account interfaces, which may allow the user of second computing device 130 to set spending throttles. The spending throttles may limit usage of a balance, credit limit, or other funds accessible to payment card 120 or the digital account accessible through second payment application 132. For example, the spending throttle may be established as a limit lower than a maximum available balance or credit limit. The spending throttles may also include other parameters, such as timeframe or cycle to reset the spending throttle, a particular time, date, MCC, merchant, location, or other transaction throttle, or other throttle parameter.

During transaction processing, second payment application 132 may be utilized to select payment instrument(s) for use in providing payment for a purchase transaction, transfer, or other financial process. As discussed herein, second payment application 132 may utilize user financial information, such as credit card data, bank account data, or other funding source data, as a payment instrument when providing payment information. Additionally, second payment application 132 may utilize a digital wallet associated with an account with a payment provider as the payment instrument, for example, through accessing a digital wallet or account of a user through entry of authentication credentials and/or by providing a data token that allows for processing using the account. However, in other embodiments, payment card 120 may be used to provide such data. Second payment application 132 may also be used to receive a receipt or other information based on transaction processing.

The account interfaces may also be used to set the spending throttles, as well as review and change the spending throttles. Further, the account interfaces may be used to designate a device to receive a notification when a spending throttle is exceeded or violated, as well as view the message notifying or alerting the user of the spending throttle violation and respond to such message. Thus, second payment application 132 may further be used to request removal or adjustment of a spending throttle in response to a message that provides an executable option to remove or adjust the spending throttle when violated. In various embodiments, second payment application 132 may correspond to a general browser application configured to retrieve, present, and communicate information over the Internet (e.g., utilize resources on the World Wide Web) or a private network. For example, second payment application 132 may provide a web browser, which may send and receive information over network 160, including retrieving website information, presenting the website information to the user, and/or communicating information to the website, including payment information for the transaction. However, in other embodiments, second payment application 132 may include a dedicated application of transaction processor 140 or other entity (e.g., a merchant), which may be configured to assist in processing transactions electronically.

In various embodiments, second computing device 130 includes other applications 134 as may be desired in particular embodiments to provide features to second computing device 130. For example, other applications 134 may include security applications for implementing client-side security features, programmatic client applications for interfacing with appropriate application programming interfaces (APIs) over network 160, or other types of applications. Other applications 134 may also include email, texting, voice and IM applications that allow a user to send and receive emails, calls, texts, and other notifications through network 160, including those associated with notifying a user when a spending throttle is exceeded and allows for removal or adjustment of the spending throttle. Other applications 134 may also include other location detection applications, which may be used to determine a location for second computing device 130, such as a mapping application. Other applications 134 may include device interface applications and other display modules that may receive input from the user and/or output information to the user. For example, other applications 134 may contain software programs, executable by a processor, including a graphical user interface (GUI) configured to provide an interface to the user. Other applications 134 may therefore use components of second computing device 130, such as display components capable of displaying information to users and other output components, including speakers.

Second computing device 130 may further include database 136 which may include, for example, identifiers such as operating system registry entries, cookies associated with second payment application 132 and/or other applications 134, identifiers associated with hardware of second computing device 130, or other appropriate identifiers. Identifiers in database 136 may be used by a payment/service provider to associate second computing device 130 with a particular account maintained by the payment/service provider. Database 136 may also further store received transaction data for processed transactions, as well as messages that notify or alert the user associated with second computing device 130 when a spending throttle is violated and removal or adjustment may be processed.

Second computing device 130 includes at least one network interface component 138 adapted to communicate with first computing device 110 and/or transaction processor 140 over network 160. In various embodiments, network interface component 138 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Transaction processor 140 may be maintained, for example, by an online service provider, which may provide processes to provide account services and process payments, as well as establish spending throttles and monitor payment card 120 and/or a digital account's usage of a balance or credit limit associated with the spending throttles. In this regard, transaction processor 140 includes one or more processing applications which may be configured to interact with first computing device 110, second computing device 130, and/or another device/server to facilitate communications and transactions between users. Transaction processor 140 may be maintained by or include another type of platform or service provider, for example, a transaction processor such as PAYPAL®, Inc. of San Jose, Calif., USA. Although first computing device 110 and transaction processor 140 are discussed as separate devices and servers, in some embodiments, one or more of the described processes of may instead be provided by the other device or server, or the same device or server.

Transaction processor 140 of FIG. 1 includes a transaction processing application 150, other applications 142, a database 144, and a network interface component 148. Transaction processing application 150, and other applications 142 may correspond to executable processes, procedures, and/or applications with associated hardware. In other embodiments, transaction processor 140 may include additional or different modules having specialized hardware and/or software as required.

Transaction processing application 150 may correspond to one or more processes to execute modules and associated specialized hardware of transaction processor 140 to process a transaction for item(s) with first computing device 110, payment card 120, and/or second computing device 130, which may be based on one or more transactions established with first computing device 110. In this regard, transaction processing application 150 may correspond to specialized hardware and/or software used by a user associated with first computing device 110 to establish an account with transaction processing application 150 by providing personal and/or financial information to transaction processor 140 and selecting authentication credentials. In various embodiments, the financial information may include payment instrument information, such as account/card numbers and information. The account may be used to purchase items and/or transfer funds, for example, through peer-to-peer payment operations 152 that allow for a peer-to-peer network and/or social networking environment that allows for interactions between different users, merchants, or other entities. The payment account may be accessed and/or used through a browser application and/or dedicated payment application. However, in other embodiments, a payment account may be generated by another online transaction processor or service provider and linked with transaction processor 140. Additionally, transaction processing application 150 may be used to create, establish, and/or link payment card 120. Transaction processing application 150 may be used to set spending throttles on usage of a balance, credit limit, or other funds for payment card 120 and/or the account. Transaction processing application 150 may process a payment and may provide a transaction history for transaction authorization, approval, or denial,

Transaction processing application 150 may correspond to a product of service provider server 120 that may be utilized by end users, such as to perform electronic payments, transfers, and the like using one or more accounts and/or financial instruments. Transaction processing application 150 may also include or utilize different processors, engines, or models as required for an authentication, account setup and maintenance, electronic transaction processing, deposit and/or withdrawal, dispute resolution, and the like, for example, through peer-to-peer payment operations 152. Transaction processing application 150 may include one or more API integrations and/or interactions with an electronic card network in order to detect, receive, and monitor transaction data for compliance with spending throttles on use of one or more balances for payment card 120 and/or a digital account of a user. Thus, transaction processing application 150 may interact with the card network for payment card 120 and/or utilized by first computing device 110 used to process payment card 120 (e.g., through one or more API calls to APIs of transaction processing application 150 that interfaces with APIs of the electronic card network). Transaction processing application 150 may first determine that transaction data for transactions processed on the network.

Transaction processing application 150 may receive the transaction data for transactions processed using payment card 120 and/or the account accessible through second computing device 130. Transaction processing application 150 may then determine spending throttles set on usage of a balance, credit limit, and/or other funds available to payment card 120 and/or the account. For example, the spending throttles may be established lower than a maximum balance amount or maximum extended credit limit. The spending throttle may therefore lower the available credit limit or other balance below the maximum amount (e.g., where a spending throttle may be for $1,000 of a $5,000 limit). Thereafter, using the API calls with the electronic card network, merchant devices (e.g., first computing device 110), and/or other devices, transactions may be detected.

Transaction processing application 150 may determine whether the transactions comply with the spending throttle(s). If so, the transaction may be approved or authorized. However, if the transaction does not comply with the spending throttle or exceeds the limit on electronic transaction processing and/or credit/balance limit, then transaction processing application 150 may be used to decline transaction processing or instruct a backend credit processor and/or merchant device to decline processing of the transaction. Further, transaction processing application 150 may transmit a message to first computing device 110 and/or another device to notifies the user that the spending throttle has been violated and provides an operation to remove or adjust the spending throttle. If the user requests removal or adjustment (and is authenticated in various embodiments), the spending throttle may be removed or adjusted by transaction processing application 150.

In various embodiments, transaction processor 140 includes other applications 142 as may be desired in particular embodiments to provide features to transaction processor 140. For example, other applications 142 may include security applications for implementing server-side security features, programmatic client applications for interfacing with appropriate application programming interfaces (APIs) over network 160, or other types of applications. Other applications 142 may contain software programs, executable by a processor, including a graphical user interface (GUI), configured to provide an interface to the user when accessing transaction processor 140, where the user or other users may interact with the GUI to more easily view and communicate information. In various embodiments, other applications 142 may include additional connection and/or communication applications, which may be utilized to communicate information to over network 160.

Additionally, transaction processor 140 includes database 144. Database 144 may store various identifiers associated with first computing device 110. Database 144 may also store account data, including payment instruments and authentication credentials, as well as transaction processing histories and data for processed transactions. Database 144 may store received data associated with a user, such as transaction data and spending throttles on electronic transaction processing. Further, database 144 may be used to store messages and responses to messages based on violating spending throttles and/or removing or adjusting the spending throttles.

In various embodiments, transaction processor 140 includes at least one network interface component 148 adapted to communicate with first computing device 110, second computing device 130, and/or another device/server for a merchant over network 160. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

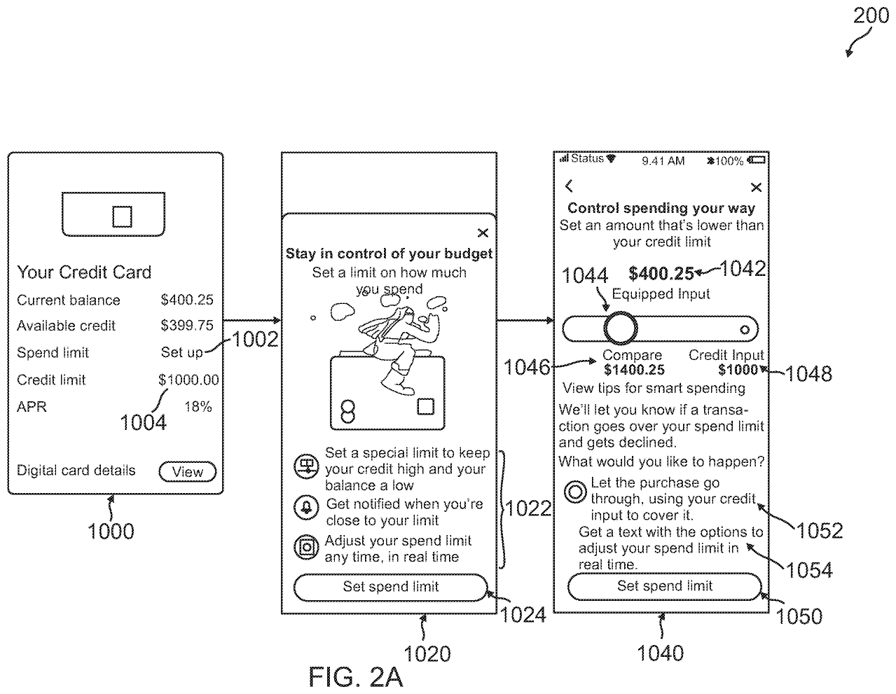

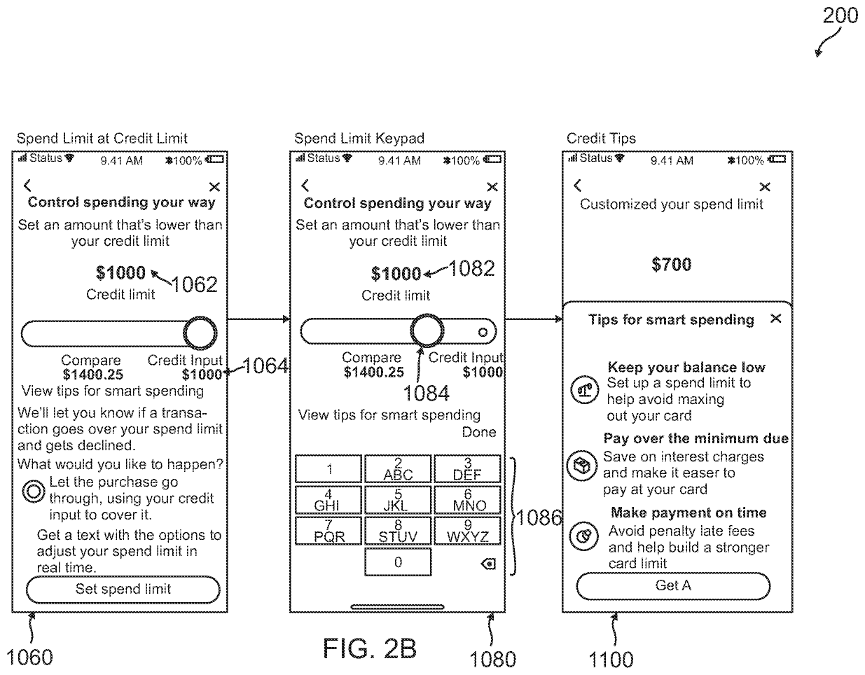

FIGS. 2A-B are exemplary interfaces 200 for establishing a processing limit on a digital account and payment card with an online transaction processor, according to an embodiment. Interfaces 200 of FIGS. 2A-B may be displayed by a computing device when setting up a spending throttle, such as by second computing device 130 when interacting with transaction processor 140 discussed in reference to system 100 of FIG. 1.

In interfaces 200 of FIG. 2A, different interactions and communications are shown in order to establish spending throttle on a credit limit available to a payment card, such as payment card 120 in system 100. For example, in an interface 1000 of interfaces 200 in FIG. 2A, a mobile application interface may allow a user to establish the spending throttle through navigating one or more selectable options. In interface 1000, a spend limit 1002 may be selected in order to limit the maximum amount of credit limit 1004, shown as $1,000. This allows for a spending throttle to be set lower than credit limit 1004 in order to better control a user's budget while allowing for the larger credit limit to assist the user in building a better credit score. After selection of spend limit 1002, an interface 1020 may then be displayed that allows a user to view a spending throttle control panel. For example, in interface 1020 of FIG. 2A, messages 1022 may be displayed that provides information about the spending throttle establishment. Selection of interface option 1024 then allows the user to navigation to an interface 1040 for entry of spending throttle information.

In interface 1040 of FIG. 2A, spending throttle 1042 is shown with a spending limit of $400.25 on the credit limit 1004. This may be done by moving slider 1044 to the desired amount for spending throttle 1042. For example, a maximum limit 1048 is shown as $1,000, while throttle amount 1046 is set to $400.25 for spending throttle 1042. Further, using option 1052, a first option 1052 is set so that a purchase may be completed using the credit limit if spending throttle 1042 is exceeded. Alternatively, a second option 1054 may be set so that a text is sent when spending throttle 1042 is exceeded that allows the user to remove spending throttle 1042 when exceeded by a transaction. Once the options within interface 1040 are set, an interface element 1050 may be selected to set the spending throttle and/or navigate to further interfaces.

In an interface 1060 of FIG. 2B, a spending throttle 1062 may be set that increases the spending throttle up to credit limit 1064. Spending throttle 1062 may therefore be set at the maximum credit limit so that no spending throttle is set below credit limit 1064. In contrast, in an interface 1080 of FIG. 2B, spending throttle 1082 may be adjusted to increase the previously established spending throttle 1042 of $400.25 to $600.25. Spending throttle 1082 may be entered using a slider 1084 and/or a keypad 1086, such as by entering input and/or adjusting the slider to the desired amount for spending throttle 1082. Thereafter, once spending throttle 1082 is entered, an interface 1100 of FIG. 2B may then be shown that provides information, tips, and other messages associated with establishing spending throttles and/or utilizing spending throttles on credit limits.

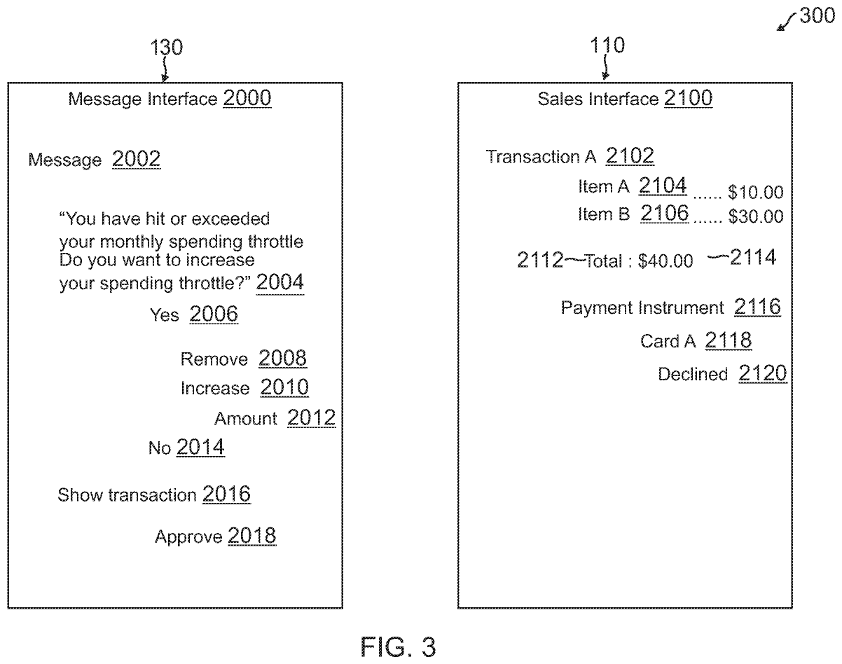

FIG. 3 is an exemplary interface for notifying a user through a mobile account when a processing throttle is reached, according to an embodiment. Environment 300 of FIG. 3 includes first computing device 110 and a second computing device 130 discussed in reference to system 100 of FIG. 1. In this regard, first computing device 110 and second computing device 130 display dynamically rendered or displayed interfaces for device applications, such as first payment application 112 and second payment application 132, respectively, based on transactions processed on an electronic processing network or other digital payment or card network.

Environment 300 therefore includes message interface 2000 for the application of second computing device 130 that provides data within a rendered or displayed user interface (UI) or GUI. Message interface 2000 may be displayed in response to a transaction A 2102 that was declined through sales interface 2100 of first computing device 110 after meeting or exceeding a spending throttle. For example, transaction A 2102 in sales interface 2100 includes an item A 2104 for an amount 2108 of $10.00 and an item B 2106 for an amount 2110 of $30.00. In response to transaction A 2102, a total 2112 may be calculated for an amount 2114 of $40.00. A payment instrument 2116 may be entered, such as payment card 120, which shows a scanned card A 2118. In other embodiments, other payment instruments linked to a credit limit having a spending throttle may also be entered, such as digital account accessible through a mobile application of second computing device 130. Thereafter, when first computing device 110 attempts to process transaction A 2102, total 2112 may cause a balance of card A 2118 to meet or exceed a spending throttle on the credit limit of card A 2118. This then results in a declined status 2120 for transaction A 2102 so that transaction A 2102 is not processed and paid for using card A 2118. In some embodiments, the options for the spending throttle of card A 2118 may be dynamic and declined status 2120 may result from different parameters. For example, a dynamic spending throttle may be time based, such as a time of month day or month where the spending throttle may be increased or decreased. Thus, declined status 2120 may result from different parameters of transaction A 2102, such as a transaction time, location, merchant, and the like.

Thus, message interface 2000 may be displayed and rendered with second computing device 130 in response to declined status 2120. Message interface 2000 includes a message 2002 informing the user that transaction A 2102 was declined in response to meeting or exceeding a spending throttle on card A 2118. In this regard, message 2002 states: “You have hit or exceeded your monthly spend throttle. Do you want to increase your spend throttle?” in text 2004. Further, message 2002 includes an executable option 2006 that allows the user to perform a remove operation 2008 for the spending throttle or an increase operation 2010 for an amount 2012 to increase the spending throttle. However, if the user wants to keep the spending throttle, a decline option 2014 may prevent the spending throttle from being removed or adjusted. Message 2002 may also provide information on transaction A 2102 through a view transaction option 2016, as well as an approval option 2018 for transaction A 2102 so that transaction A 2102 may be approved without having to re-enter the transaction information and payment instrument 2116.

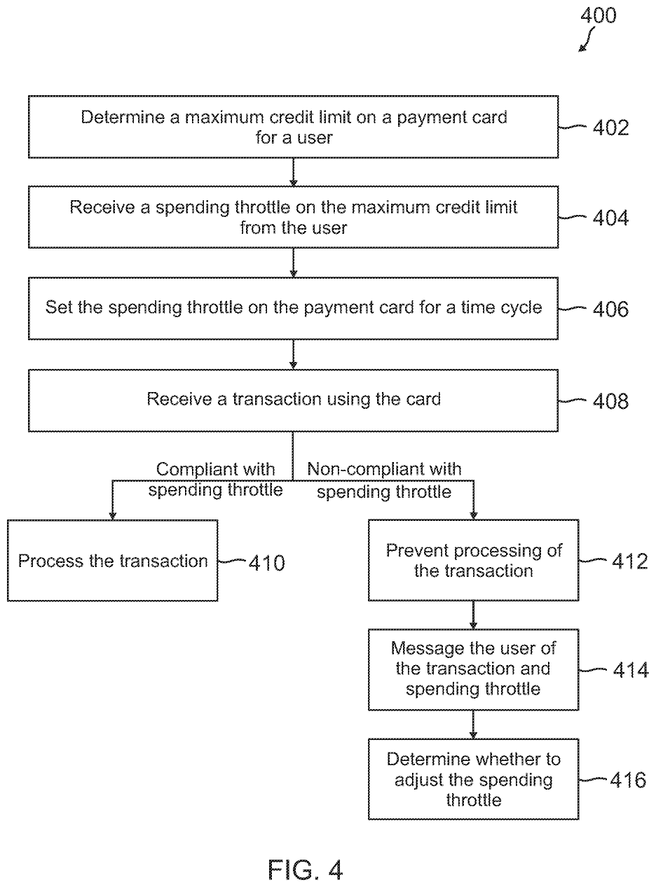

FIG. 4 is a flowchart of an exemplary process for processing throttles to enforce account usage limitations, according to an embodiment. Note that one or more steps, processes, and methods described herein of flowchart 400 may be omitted, performed in a different sequence, or combined as desired or appropriate.

At step 402 of flowchart 400, a maximum credit limit on a payment card for a user is determined. The maximum credit limit may be an entire amount of credit extended to the user for a particular credit card or other credit account. However, the maximum credit limit may not want to be used by the user, for example, so that the user adheres to a budget while still building credit. Thus, at step 404, a spending throttle on the maximum credit limit is received from the user. The spending throttle may be received to place a cap on usage of the maximum credit limit below the maximum credit limit. Further the spending throttle may be set with other parameters, such as transaction type, time, or location based. The spending throttle may also be by certain transaction categories, such as MCCs. Moreover, the spending throttle may be established with one or more options to adjust the spending throttle if the spending throttle is reached. For example, the spending throttle may be set with a contact identifier so that a message may be transmitted to the user to remove the spending throttle.

At step 406, the spending throttle is set of the payment card for a time cycle. When the spending throttle is set, the payment card may be monitored for usage over an electronic card network. Thus, the online transaction processor that monitors and/or controls the payment card may include an integration with the payment card's processing network. This allows the online transaction processor to, at step 408, receive a transaction using the card. The transaction may include transaction data, such as an amount of the transaction and other information including time, MCC, merchant name, location, and the like. The transaction data may therefore have information that may be compared to parameters of a spending throttle to determine compliance with the spending throttle.

Thereafter, the online transaction processor may determine whether the transaction is compliant with the spending throttle. If the transaction complies with and does not violate the parameters, such as the threshold amount for the spending throttle, at step 410, the transaction is processed, such as by allowing the transaction to proceed and a payment to be processed. However, if the transaction is not compliant with the spending throttle, at step 412, the processing of the transaction is prevented. This may include transmitting a message or request over the network to the backend card processor to reject the transaction. In further embodiments, the online transaction processor may directly prevent processing of the transaction. At step 414, the user is then messaged with information of the transaction and the spending throttle. This may be transmitted through an SMS/MMS message, a push notification for an application, and email, or other communication channel. Thereafter, the online transaction processor determines whether to adjust the spending throttle, at step 416. The online transaction processor may adjust the spending throttle by receiving a request to remove or increase the spending throttle, for example, in response to the message sent to the user. The online transaction processor may remove or increase the spending throttle, which may allow the transaction to be processed.

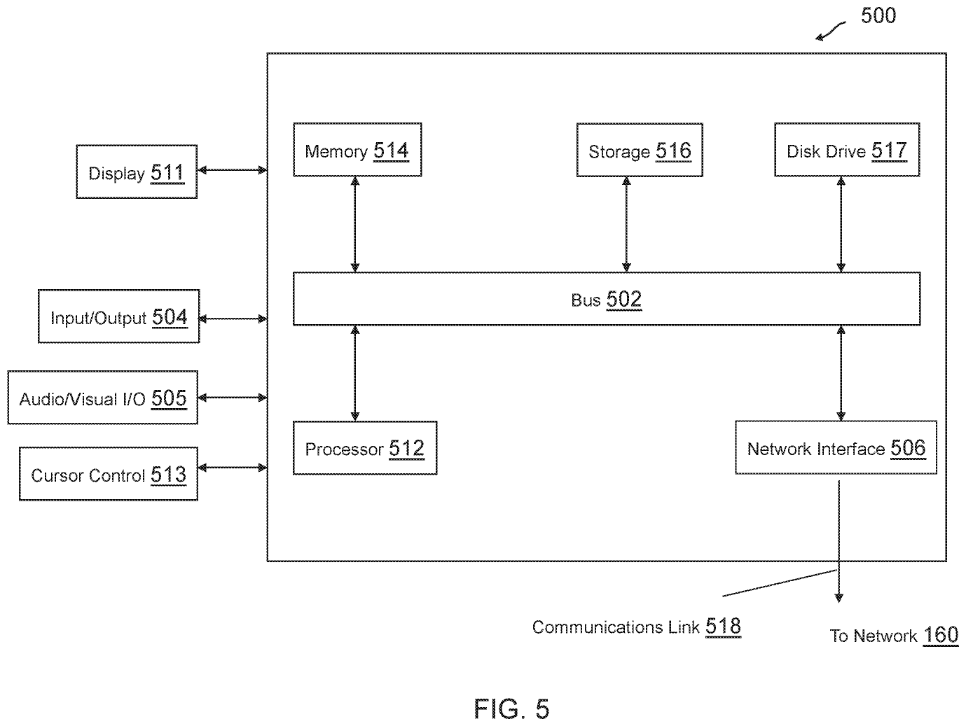

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
determining, via a connection by the system with an electronic payment network, a first card transaction with a merchant using a payment card, wherein the payment card is linked to a digital account for an online platform peer-to-peer network of the system;
determining a transaction processing limit set for a use of payment card, wherein the transaction processing limit is below a maximum credit amount available to at least one of the payment card or the digital account, and wherein the transaction processing limit prevents the use of the payment card over the transaction processing limit;
determining that the first card transaction complies with the transaction processing limit; and
approving, via the connection based on the determining that the first card transaction complies with the transaction processing limit, the first card transaction for processing via the electronic payment network.

2. The system of claim 1, wherein the operations further comprise:
determining, via the connection, a second card transaction using the payment card;
determining that the second card transaction violates the transaction processing limit based on an increased balance for at least one of the payment card or the digital account after the first card transaction; and
rejecting, via the connection based on the determining that the second card transaction violates the transaction processing limit, the second card transaction for processing via the electronic payment network.

3. The system of claim 2, wherein the operations further comprise:
transmitting a notification to a mobile device of a user associated with the payment card, wherein the notification comprises an option to remove the transaction processing limit and utilize the maximum credit amount;
in response to the transmitting the notification, receiving a removal request of the transaction processing limit via the option; and
removing the transaction processing limit on the payment card.

4. The system of claim 3, wherein the option requires an authentication for the digital account required by the user to remove the transaction processing limit.

5. The system of claim 1, wherein prior to the detecting, the operations further comprise:
receiving an identification of the payment card via the digital account;
receiving the transaction processing limit set below the maximum credit amount for the payment card; and
establishing the transaction processing limit with the payment card using the identification.

6. The system of claim 5, wherein the transaction processing limit is set for a time period associated with a usage of the maximum credit amount via the payment card, and wherein the transaction processing limit comprises a spending limit below the maximum credit amount during the time period.

7. The system of claim 5, wherein the transaction processing limit further comprises a transaction type limit on the payment card based on one or more merchant category codes (MCCs).

8. The system of claim 5, wherein prior to the establishing, the operations further comprise:
receiving a removal operation for removing the transaction processing limit for the payment card, wherein the removal operation identifies a device of a user associated with the payment card to receive a notification associated with the removal operation; and wherein the removal operation further identifies a communication channel for transmission of the notification to the device,
wherein the establishing the transaction processing limit with the payment card further uses the removal operation.

9. The system of claim 1, wherein the maximum credit amount is available to the payment card for in-person transactions and the digital account for digital transactions, and wherein the transaction processing limit is shared between the payment card and the digital account.

10. The system of claim 1, wherein the payment card comprises one of a plurality of payment cards linked to the maximum credit amount, and wherein the transaction processing limit is specific to the payment card from the plurality of payment cards.

11. A method comprising:
receiving, by an online transaction processor from an electronic card network, first transaction data for a transaction between a user and a merchant processed using a physical card, wherein the physical card is linked to a digital account of the user with the online transaction processor;
determining, by the online transaction processor, a first spending throttle on the physical card set by the user, wherein the first spending throttle comprises an amount available for transaction processing on the electronic card network set below a maximum amount available to the physical card for the transaction processing on the electronic card network;
determining, by the online transaction processor, that the transaction violates the first spending throttle based on the first transaction data and the amount for the first spending throttle; and
rejecting, by the online transaction processor, a processing of the transaction on the electronic card network based on the determining that the transaction violates the first spending throttle.

12. The method of claim 11, further comprising:
receiving a second spending throttle to adjust the first spending throttle above or below the amount available for the transaction processing associated with the first spending throttle; and
adjusting the first spending throttle to the second spending throttle.

13. The method of claim 11, wherein the maximum amount available for the transaction processing comprises a credit limit established for the physical card when the physical card is opened through the electronic card network by a backend card processor.

14. The method of claim 11, further comprising:
transmitting an alert to a device of the user that indicates the rejecting the processing of the transaction.

15. The method of claim 14, further comprising:
in response to the transmitting the alert, receiving a request to adjust the first spending throttle to increase the amount available for the transaction processing associated with the first spending throttle; and
adjusting the first spending throttle based on the request.

16. The method of claim 15, further comprising:
requesting an approval to allow the transaction based on the adjusted first spending throttle from the device;
receiving the approval from the device; and approving the transaction based on the adjusted first spending throttle and the approval.

17. The method of claim 15, further comprising:
receiving second transaction data corresponding to the transaction between the user and the merchant processed using the physical card; and
approving the transaction based on the adjusted first spending throttle and the second transaction data.

18. The method of claim 15, wherein the request comprises one of a tiered release of an additional amount of the maximum amount available to the physical card for the transaction processing on the electronic card network or a removal of the first spending throttle on the maximum amount.

19. The method of claim 18, wherein the digital account comprises a peer-to-peer payment account on a peer-to-peer payment network provided by the online transaction processor, and wherein the peer-to-peer payment network includes a social networking feed for the peer-to-peer payment account.

20. A non-transitory machine-readable medium having stored thereon machine-readable instructions executable to cause a machine to perform operations comprising:
causing to be displayed, via a user interface in an application on a device, at least one interface element associated with establishing a spending throttle on a credit extension to an account of a user, wherein the credit extension has a maximum credit amount and is linked to an account of the user with a peer-to-peer payment network;
receiving a throttle credit limit for the spending throttle from the application via the user interface, wherein the throttle credit limit is less than the maximum credit amount;
establishing the throttle credit limit for the credit extension with the account of the user; and
monitoring the credit extension for the account on an electronic card network based on the spending throttle.
